(19) United States
(12) Patent Application Publication
(10) Pub. No.: US 2008/0264030 A1
(43) Pub. Date: Oct. 30, 2008

(54) STEM CLIPPER AND CRUSHER MECHANISMS FOR USE WITH FRUIT TREES AND THE LIKE

(75) Inventors: Vincent E. Bryan, Quincy, WA (US); Alex E. Kunzler, Issaquah, WA (US); Jeffrey A. Cleveringa, Ephrata, WA (US); Daniel Baker, Seattle, WA (US); Joseph A. Penaranda, Renton, WA (US)

Correspondence Address: TODD S. PARKHURST;HUGHES SOCOL PIERS RESNICK & DYM LTD., THREE FIRST NATIONAL PLAZA, 70 WEST MADISON- SUITE 4000, CHICAGO, IL, 60602, US

(73) Assignee: Picker Technologies LLC, Mercer Island, WA (US)

(21) Appl. No.: 12/061,059

(22) Filed: Apr. 2, 2008

Related U.S. Application Data
(60) Provisional application No. 60/921,707, filed on Apr. 4, 2007.
(60) Provisional application No. 60/949,533, filed on Jul. 13, 2007.

(51) Int. Cl. A01D 46/24; B26B 15/00

(52) U.S. Cl. 56/328.1; 30/228

(57) ABSTRACT

A clipper or shearing mechanism for separating a produce item such as an apple from the plant upon which it has grown such as an apple tree is disclosed. The mechanism provides a stem separating or severing mechanism comprising at least two mutually movable elements adapted to engage and sever the stem of the produce item. A trigger can be provided to actuate the stem severing mechanism. If desired, a mounting mechanism for mounting the severing elements in a predetermined position relative to a produce intake element can be provided as well. The mechanism can also be provided with crushing mechanisms to crush and soften an exposed portion of the produce item stem. The crushed stem will be less likely to poke and consequently damage adjacent produce items.

This application claims priority from U.S. provisional patent application Ser. No. 60/921,707 filed Apr. 4, 2007; and from U.S. provisional patent application Ser. No. 60/949,533 filed Jul. 13, 2007.

This invention relates to clippers, shears, and crushers and like mechanisms for use with separating fruits, citrus and other produce from the trees or other plants upon which they have been grown.

### BACKGROUND OF THE INVENTION

As described in co-pending U.S. utility patent application Ser. No. 12/055,209 filed Mar. 25, 2008, apples and other produce are traditionally hand-picked from the trees or other plants upon which they are grown. The picking personnel carefully separate the apples from the trees and then place the picked fruit in bags which are worn by the pickers. The pickers then gently place the fruit from the bags into bins for transport. It is in the interests of the picking crew members, the crew managers, the orchard operators, the orchard owners, the ultimate consumers, and everyone else involved that the productivity of the picking crew members be increased without risking damage to the produce or to the plants from which that produce is picked. The transport system described in the above-referenced co-pending patent application and this present invention will substantially increase the productivity of the picking personnel.

One object of this invention to provide a mechanism to permit a picker to sever a produce object such as a fruit, citrus or other element from the plant upon which it has grown in such a way as to encourage subsequent produce growth at the original severance site.

Another object of the invention is to provide shears or a clipper which will furnish a cut stem that will not damage or deleteriously rub neighboring fruit during loading, transport or packing.

A related object of the invention is to provide such mechanisms in forms which will permit the user to more easily and more speedily perform his or her picking tasks.

Yet another object of the invention is to provide severing mechanisms which are easy and quick to operate, reliable in use, and inexpensive to manufacture.

Other objects and advantages of the invention will become apparent upon reading the following description and upon reference to the drawings. Throughout the drawings, like reference numerals refer to like parts.

### BRIEF DESCRIPTION OF THE DRAWINGS

FIG. 1 is an elevational view showing a picker using an embodiment of the present invention in picking apples from an apple tree and depositing the picked apples in an upstream portion of a transport device.

FIG. 2 is a fragmentary elevational view in section showing an apple tree branch, an apple clipper device, and the upstream end of the transport device of FIG. 1.

FIG. 3 is a plan view of the clipper device shown in FIG. 2.

FIG. 4 is an elevational view of the clipper device shown in FIG. 3.

FIG. 5 is a top plan view showing portions of the clipper device shown in FIGS. 3 and 4.

FIG. 6 is a schematic drawing showing an apple and the apple stem engagement jaws of an alternate embodiment of the invention.

FIG. 7 is a schematic drawing of the apple stem engagement jaws shown in FIG. 6 as they appear when the Apple is being severed from its stem.

FIG. 8 is a schematic drawing of stem engagement jaws of a second alternate embodiment of the invention.

FIG. 9 is a schematic view of stem engagement jaws of a third alternate embodiment of the invention.

FIGS. 10a through 10e comprise schematic drawings showing the operation of yet a fourth embodiment of the invention in which the stem is severed and then axially crushed.

FIGS. 11a through 11c comprise schematic drawings showing the operation of a fifth embodiment of the invention in which the stem is radially crushed.

### DETAILED DESCRIPTION

While the invention will be described in connection with several preferred embodiments and procedures, it will be understood that it is not intended to limit the invention to these embodiments or procedures. On the contrary, it is intended to cover all alternatives, modifications and equivalents as may be included within the spirit and scope of the invention as defined by the appended claims.

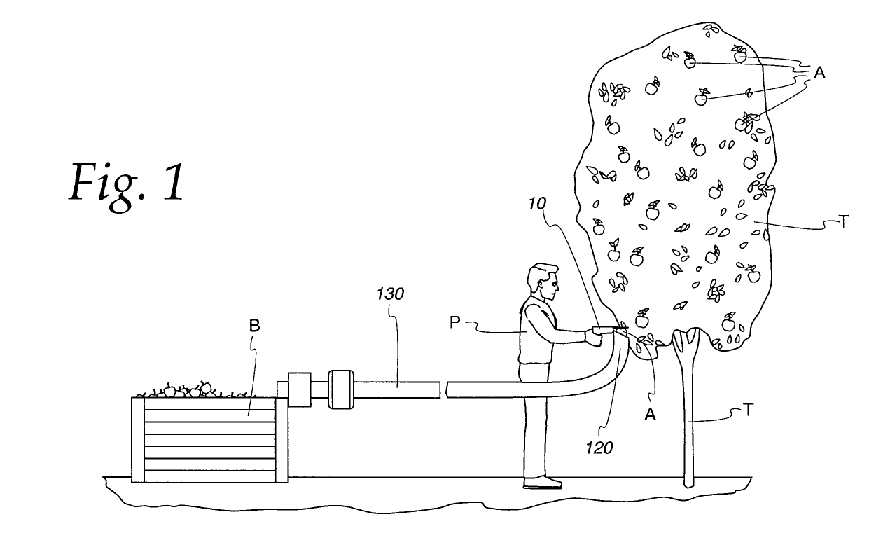

Turning first to FIG. 1, there is shown a picker P picking apples A from a tree T. The picker P is using a clipper or shears 10 embodying the present invention. A severed apple A is dropping into a chute 120 which delivers the apple to a pneumatic tube 130. The tube 130 delivers the apples, in turn, to a bin B for transport to a remote processing station (not shown). This tube system can be of the sort described, shown and claimed in co-pending U.S. patent application Ser. No. 12/055,209 filed Mar. 25, 2008. It will be understood that the chute 120 is, in practice, positioned and carried on the chest of the picker P by a harness (not shown) comprising a number of straps. The picker P can be standing on the ground as shown, or can be standing on a ladder, or can be mounted on a platform which is mounted, in turn, on a mobile chassis (not shown). The transport tube system can also be mounted on that mobile platform of the sort disclosed in co-pending U.S. patent application Ser. No. 61/028,351 filed Feb. 13, 2008. In the illustrated arrangement, the chute 120 and tube 130 are pivoted or flexible so as to permit the picker P to move about as necessary to accomplish the picking tasks.

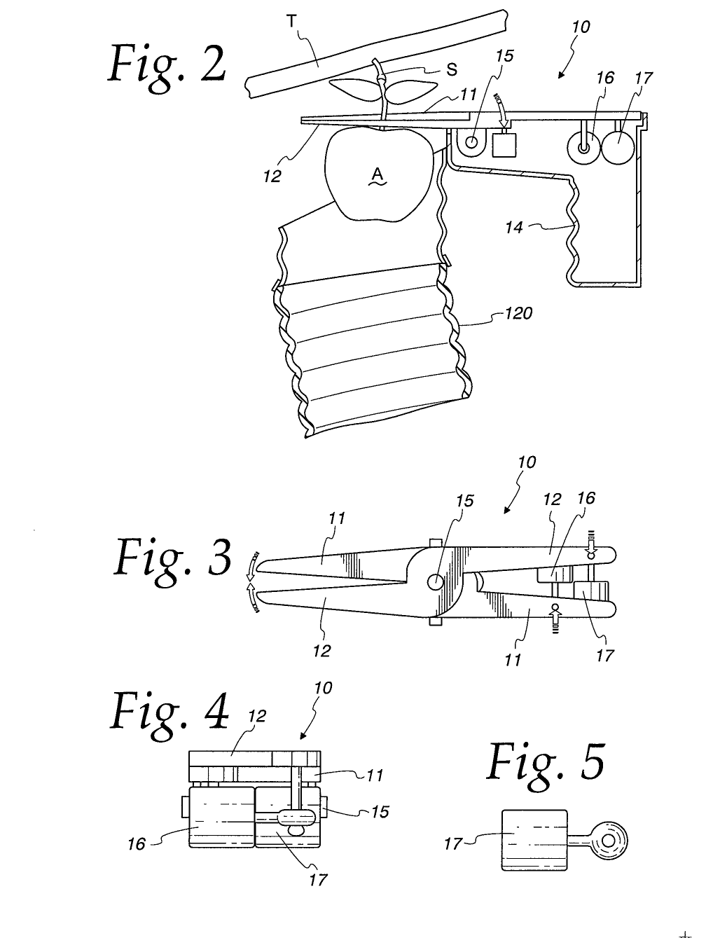

In accordance with the invention, the apples or other produce can be quickly and properly severed from the tree T or other plant upon which they are grown by the picking shears or severing mechanism 10. Alternatively, the apple can be picked by hand or some other mechanical device, and then the stem portion still attached to the apple can be trimmed, sheared, severed or crushed by the present invention. A first embodiment of this mechanism is shown more particularly in FIGS. 2-5 and elsewhere. In this embodiment, the shears 10 are provided with two scissor-like blades 11, 12 interconnected by a pivot 13. The blades 11, 12 are mounted, in turn, upon a pistol-grip-like handle 14. When the picker P positions the mechanism 10 as shown in FIG. 2, and then presses the blades 11, 12 down so as to contact the top of the apple A, the blades 11, 12 pivot about a pivot 15, which causes the rear of the blades to contact actuators 16, 17. These actuators 16, 17, actuate a power supply and drive (not shown) to cause the blades 11, 12 to move towards one another and provide a shearing, cutting action to the stem S shown in FIG. 2. The severed apple A then drops into the chute 120 and is transported by the tube 130 (FIG. 1) to a bin B for further transport and processing.

It will be noted that, by arranging the mechanism of the device 10 so as to cut the stem S in this way, the apple stem is severed at a point more or less in the plane—or even slightly below the plane—of the apple top, so that the stem does not protrude from the apple body. By this arrangement, that portion of the apple stem S still connected to the apple body is relatively unlikely to poke or rub other apples and thereby blemish or cause other sorts of damage to those other apples. Blemished or damaged apples are less attractive and less valuable than unblemished, undamaged apples.

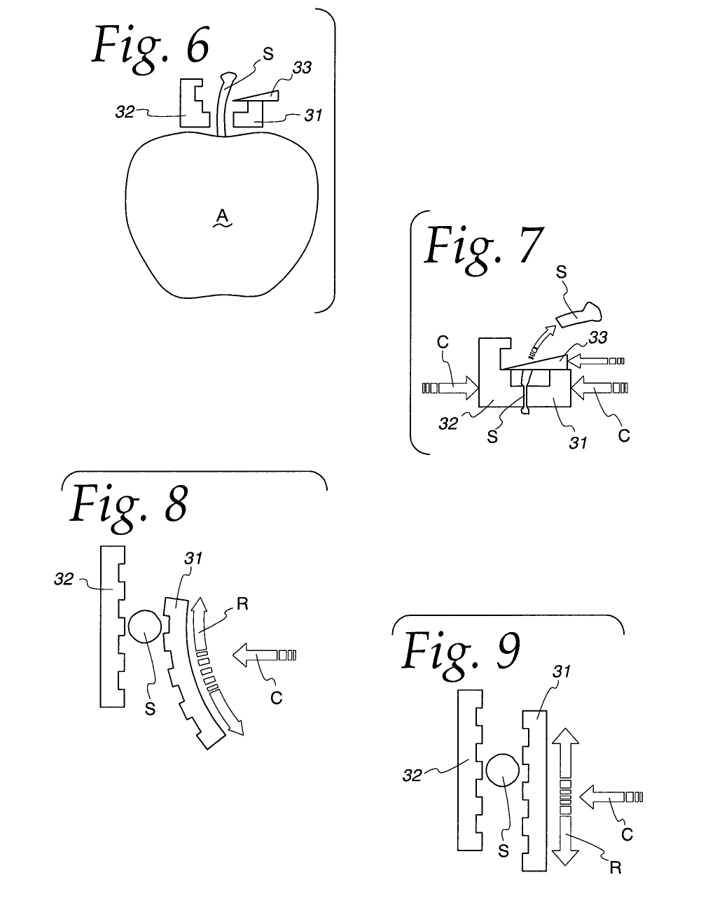

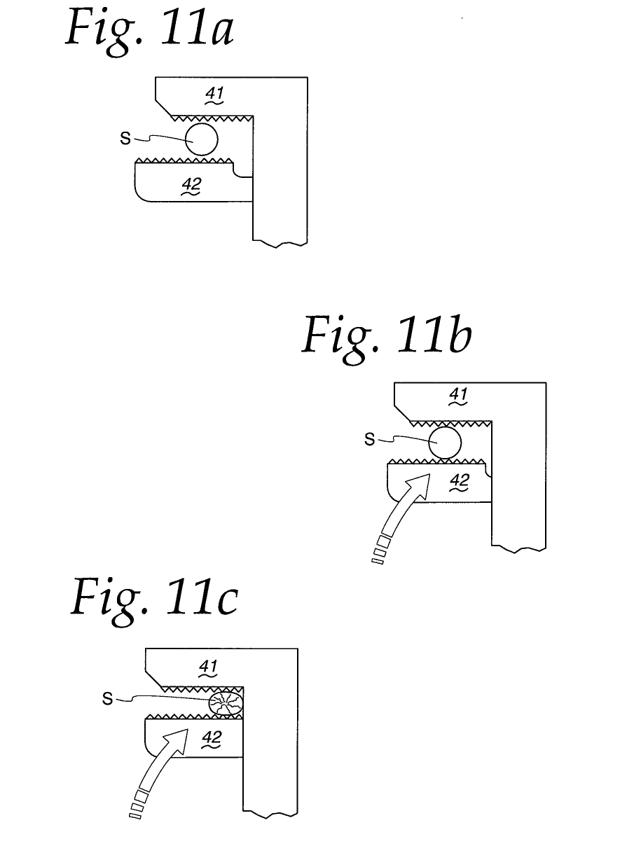

In one embodiment of the invention shown in FIGS. 6-9, that portion of the apple stem S which is located between the point at which the apple stem is severed and the apple body can be crushed and thereby softened so as to ameliorate the effect of stem poking or rubbing on adjacent apples. To accomplish this objective in accordance with this aspect of the invention, mechanism jaws 31, 32 are provided. Here the jaw or blade 31 includes a cutter formation 33 adapted to sever the stem S as suggested in FIGS. 6 and 7. Further pivoting action of the jaws or racks 31, 32 is directed by known mechanism (not shown) to drive the first jaw 31 into confronting relationship with the second jaw 32 (arrow C in FIG. 8) and then past the second jaw 32 so as to rotate, squeeze and crush a portion of the stem S (arrow R in FIG. 8). An alternate embodiment of this arrangement is shown in FIG. 9 where both the first jaw or rack 31 and the second jaw or rack 32 are rectangular in shape and more or less pure translational motion is involved. Similar stem crushing operations are provided by the jaws or racks 41 and 42 shown in FIGS. 11a-11c.

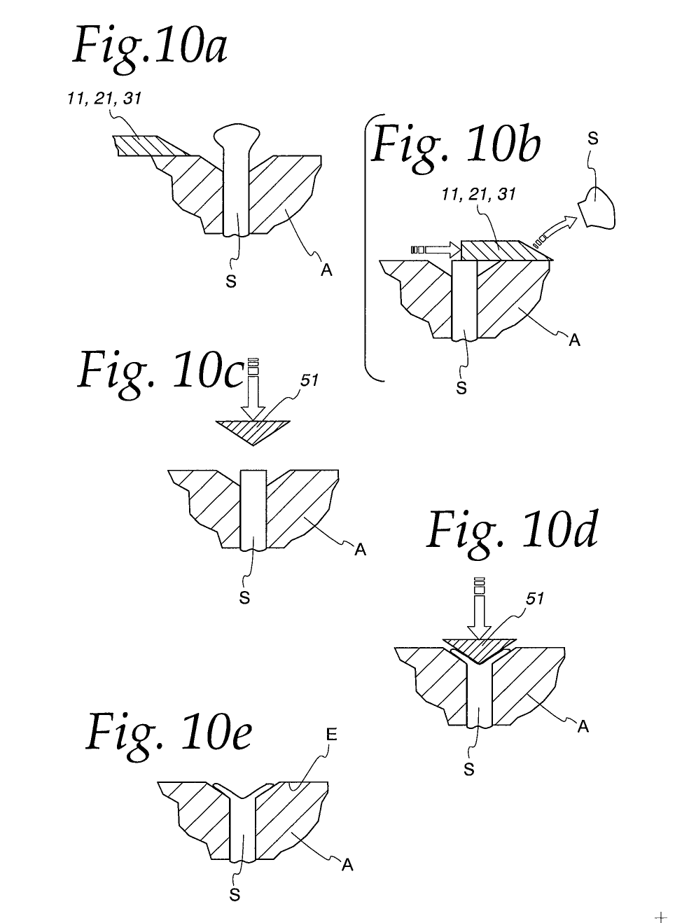

Another arrangement for crushing the stem S so as to avoid to adjacent apples is suggested in FIGS. 10a-10e. Here, a shearing element 11, 21, or 31 cuts the stem S as indicated in FIGS. 10a and 10b. Thereafter a dilator member 51 moves in a direction generally congruent with the axis of the tip of the severed stem S (arrow D) below the periphery E of the apple A.

It will be understood that the apple can be picked from the tree by hand or by a known device, and thereafter the stem portion which is still attached to the apple can be shortened and/or crushed by using the present invention. This stem shortening or crushing will inhibit damage to neighboring apples in a bag, bin, or other receptacle by a stiff protruding stem.

1. A mechanism for separating a produce item from the plant upon which it has grown, the mechanism comprising:
a stem severing mechanism comprising at least two mutually movable elements adapted to engage and sever a produce stem; and
a trigger adapted to actuate the stem severing mechanism.

2. A mechanism according to claim 1 including means for automatically actuating the trigger mechanism and operating the severing mechanism whenever the severing mechanism blades are placed adjacent to a produce stem.

3. A mechanism according to claim 1 including means for automatically actuating the trigger mechanism and operating the severing mechanism whenever the trigger mechanism engages an unsevered produce item.

4. A mechanism for separating a produce item from the plant upon which it has grown, the mechanism comprising:
a stem severing mechanism comprising at least two mutually movable elements adapted to engage and sever a produce stem; and
a mounting mechanism for mounting the severing elements in a predetermined position relative to a produce intake element.

5. A mechanism according to claim 4 further including a produce intake element, and a pneumatic tube connected to the produce intake element for receiving any severed produce item from the intake element.

6. A mechanism according to claim 1 further including means for attaching the mechanism to a human hand in a position to be operated by the hand so as to sever a produce item stem.

7. The mechanism according to claim 1 further including mechanism for crushing the produce item stem at a location between the produce item itself and the severed end of the stem.

8. The mechanism according to claim 7 wherein said crushing mechanism includes opposed rack members.

9. The mechanism according to claim 8 wherein said opposed rack members are disposed to be moved toward and away from one another so as to compress and crush the fruit stem located between them.

10. The mechanism according to claim 8 wherein said opposed rack members are disposed to be moved adjacent to and past one another so as to apply a shearing, crushing action to a fruit stem located between them.

11. The mechanism according to claim 7 wherein said crushing mechanism includes a dilator member movable in a direction generally congruent with the axis of the tip of the severed stem.

12. A mechanism for acting upon the stem of a produce item, the mechanism comprising:
a stem severing mechanism comprising at least two elements movable relative to one another and adopted to engage and sever the produce stem; and
mechanism for crushing a portion of the stem which is still attached to the produce item.
